(19) United States
(12) Patent Application Publication
(10) Pub. No.: US 2015/0091204 A1
(43) Pub. Date: Apr. 2, 2015

(54) METHOD FOR PRODUCING POLYIMIDE FILM, AND POLYIMIDE FILM

(71) Applicant: UBE INDUSTRIES, LTD., Ube-shi, Yamaguchi (JP)

(72) Inventor: Takeshi Uekido, Yamaguchi (JP)

(73) Assignee: UBE INDUSTRIES, LTD., Ube-shi, Yamaguchi (JP)

(21) Appl. No.: 14/389,159

(22) PCT Filed: Mar. 28, 2013
(86) PCT No.: PCT/JP2013/059230

§ 371 Date: Sep. 29, 2014

(30) Foreign Application Priority Data
Mar. 29, 2012 (JP) 2012-077758

(51) Int. Cl. B29C 41/00

(52) U.S. Cl. CPC B29C 41/003; B29K 2077/00
USPC 264/167

(57) ABSTRACT

Provided is a method for producing a polyimide film on which a texture having an irregular profile is formed on the surface.

A method for producing a polyimide film in which a first polyimide precursor solution containing a polyamic acid and a solvent is cast or applied onto a support and heated, wherein the first polyimide precursor solution contains an organic material different from the polyamic acid and the solvent, the volatilization temperature of the organic material is lower than the volatilization temperature of the polyimide obtained by imidization of the polyamic acid, the maximum temperature during heating is at or above the volatilization temperature of the organic material, and at or below the volatilization temperature of the polyimide, and in the process of heating the first polyimide precursor solution cast or applied onto the support and forming a polyimide, the organic material experiences phase separation from the polyimide precursor phase, and is eliminated from the polyimide film through thermal decomposition or vaporization due to the heating.

### TECHNICAL FIELD

The present invention relates to a method for producing a polyimide film having a texture with an irregular profile formed on the surface, and to a polyimide film; and more particularly relates to a method for producing a polyimide film suitable for use as a solar cell substrate, as a base substrate for a printed circuit board or the like, and to a polyimide film.

### BACKGROUND ART

Polyimide films have high heat resistance and strong electrical insulating performance, and, even in thin film form, are satisfactory in terms of the rigidity necessary for handling, heat resistance, and electrical insulating properties. For this reason, such films are widely used in industrial fields as electrical insulating films, thermal insulation films, base films for flexible circuit boards, and the like. Such films have also shown promise of late as solar cell substrates and the like.

An example of a method for producing a polyimide film having an irregular profile formed on the surface is given in Patent Document 1, in which a polyamide resin layer (A) and a polyamide resin layer (B), the latter incorporating 100-500 wt % of insulating microparticles having a mean particle diameter of 0.1-1.0 μm, are applied in the stated order while a metal substrate in the form of a band is moved. A heat treatment is conducted, and the resin layers are pressurized in a fluidized state using a roll to disperse the insulating microparticles, yielding a polyimide film on which an irregular profile is formed.

### PRIOR ART DOCUMENTS

### Patent Documents

[Patent Document 1] Japanese Laid-Open Patent Application No. 2000-91606

### DISCLOSURE OF THE INVENTION

### Problems to be Solved by the Invention

However, when insulating microparticles are compounded in a polyimide film to form an irregular profile as indicated in Patent Document 1, a large quantity thereof must be used, which has led to higher materials costs. Additionally, compounding large quantities of insulating microparticles in a polyimide film embrittles the polyimide film, which can reduce its strength.

Accordingly, it is an object of the present invention to provide a method for producing a polyimide film whereby a polyimide film on which a texture of irregular profile is formed can be produced with good productivity; and a polyimide film.

### Means to Solve the Problems

The method for producing a polyimide film of the present invention consists in a method for producing a polyimide film in which a first polyimide precursor solution containing a polyamic acid and a solvent is cast or applied onto a support and heated, wherein the method is characterized in that

the first polyimide precursor solution contains an organic material different from the polyamic acid and the solvent;

the volatilization temperature of the organic material is lower than the volatilization temperature of the polyimide obtained by imidization of the polyamic acid;

the maximum temperature during the heating is at or above the volatilization temperature of the organic material, and at or below the volatilization temperature of the polyimide; and

in the process of heating the first polyimide precursor solution cast or applied onto the support and forming a polyimide, the organic material experiences phase separation from the polyimide precursor phase, and is eliminated from the polyimide film through thermal decomposition or vaporization due to the heating.

In preferred practice, the method for producing a polyimide film of the present invention involves thermal decomposition or vaporization of the organic material to form crater-shaped recessed portions in a surface layer of the polyimide film.

In preferred practice, the method for producing a polyimide film of the present invention involves casting or applying the first polyimide precursor solution onto a support, followed by drying to obtain a first self-supporting film, followed by peeling the first self-supporting film from the support, and heating the peeled first self-supporting film.

In preferred practice, in the method for producing a polyimide film of the present invention, the support is a second self-supporting film obtained through drying of a second polyimide precursor solution.

In preferred practice, in the method for producing a polyimide film of the present invention, rather than casting or applying a first polyimide precursor solution onto a support, a first polyimide precursor solution and a third polyimide precursor solution are cast or applied in layers onto a support and dried to obtain a third self-supporting film, followed by peeling the third self-supporting film from the support, and heating the peeled third self-supporting film.

In preferred practice, in the method for producing a polyimide film of the present invention, the organic material employed is one that dissolves in the solvent. In this mode, the organic material is preferably at least one selected from polymethyl methacrylate, polyethyl methacrylate, and other polyalkyl methacrylates, poly 2-ethylhexyl acrylate, polybutyl acrylate, and other polyalkyl acrylates, and cellulose acetate.

In preferred practice, in the method for producing a polyimide film of the present invention, the organic material employed is an organic material formed into a particulate, and incompatible with the solvent. In preferred practice, the mean particle diameter of the organic material is 1-10 μm. In preferred practice, the organic material is at least one selected from crosslinked methyl methacrylate particles and polystyrene particles.

In preferred practice, in the method for producing a polyimide film of the present invention, the maximum temperature during the heating is 400-600° C.

In preferred practice, in the method for producing a polyimide film of the present invention, the volatile content of the organic material at 400° C. is 95 mass % or greater.

In preferred practice, in the method for producing a polyimide film of the present invention, the volatile content of the polyimide at 450° C. is 5 mass % or less.

The polyimide film of the present invention is characterized by being obtained by the aforedescribed method. In preferred practice, the height differential between the projected portions and the recessed portions of the recessed and projected portions formed on the surface layer is 0.1-5 μm.

The polyimide film of the present invention is a polyimide film obtained from a tetracarboxylic acid component and a diamine component, wherein the polyimide film is characterized by being provided with crater-shaped recessed portions formed towards the film interior from the surface in the thickness direction of the film; the crater-shaped recessed portions have a depth of greater than 0 but no more than 15 μm, and a diameter of greater than 0 but no more than 50 μm.

In preferred practice, the polyimide film of the present invention is a substrate for a solar cell or a base substrate for a printed circuit board.

The solar cell of the present invention is preferably one employing the polyimide film as the solar cell substrate.

The printed circuit board of the present invention is preferably one having a conductive pattern formed on a base substrate composed of the polyimide film.

### Advantageous Effects of the Invention

According to the polyimide film production method of the present invention, the organic material contained in the polyimide precursor solution is eliminated through thermal decomposition or vaporization when the cast polyimide precursor solution is heated, forming crater-shaped recessed portions on the surface of the polyimide film, and forming recesses and protrusions on the surface× layer of the polyimide film.

Because the organic material is substantially volatilized, the heated polyimide film experiences no risk of brittleness due to the presence of the organic material, and a polyimide film of exceptional strength can be obtained.

When a polyimide film produced in this manner is employed, for example, as a solar cell substrate or the like, it is possible for a variety of thin films deposited on the polyimide film, such as electrode layers, photoelectrical conversion layers, and the like, to have consistently excellent performance. For this reason, the polyimide film is suited to being employed as a solar cell substrate. When a polyimide film produced in this manner is employed, for example, in a printed circuit board, cohesion with conductive patterns formed on the polyimide film can be enhanced. For this reason, the polyimide film is suited to being employed as a base substrate for a printed circuit board.

### BRIEF DESCRIPTION OF THE DRAWINGS

FIG. 1 is a diagram of results of SEM observation (at 8,000×) of the polyimide film of Example 1; and

FIG. 2 is a diagram of results of SEM observation (at 1,000×) of the polyimide film of Example 3.

### BEST MODE FOR CARRYING OUT THE INVENTION

The method for producing a polyimide film of the present invention is one in which a first polyimide precursor solution containing a polyamic acid and a solvent is cast or applied onto a support and heated, characterized in that the first polyimide precursor solution contains an organic material different from the polyamic acid and the solvent, the volatilization temperature of the organic material being lower than the volatilization temperature of the polyimide obtained by imidization of the polyamic acid, and the maximum temperature during heating being at or above the volatilization temperature of the organic material, and at or below the volatilization temperature of the polyimide. A detailed description follows.

(First Polyimide Precursor Solution)

The first polyimide precursor solution employed in the method for producing a polyimide film of the present invention is a mixture of a polyamic acid and a solvent (hereafter sometimes referred to as a polyamic acid solution), to which an organic material has been added.

There is no particular limitation as to the solids concentration (polymer component) of the first polyimide precursor solution, provided that the resulting viscosity range will be suitable for film production through casting or applying. For example, in the case of film production by casting, a level of 10-30 mass % is preferred, with 15-27 mass % being more preferable, and 16-24% still more preferable. In the case of film production by applying, a level of 1-20 mass % is preferred, with 1.5-15 mass % being more preferable, and 2-10 mass % still more preferable.

The solution viscosity of the first polyimide precursor solution may be selected, as appropriate, according to the purpose of use (applying, casting, or the like) and the purpose of production. For example, from the standpoint of operational performance when handling the first polyimide precursor solution, the rotational viscosity of the first polyimide precursor solution, measured at 30° C., is preferably 0.1-5,000 poise. Consequently, in preferred practice, the polymerization reaction of the tetracarboxylic acid component and the diamine component will be allowed to proceed until the resulting polyamic acid exhibits the viscosity described above.

The components of the first polyimide precursor solution shall be discussed below.

(Polyamic Acid)

The polyamic acid can be produced by reacting the tetracarboxylic acid component and the diamine component. For example, production can be accomplished by polymerizing the tetracarboxylic acid component and the diamine component in a solvent of the sort commonly used in production of polyimides. The reaction temperature is preferably 100° C. or below, more preferably 80° C. or below, and especially preferably 0-60° C.

As the aforementioned tetracarboxylic acid component, there may be cited aromatic tetracarboxylic dianhydrides, aliphatic tetracarboxylic dianhydrides, alicyclic tetracarboxylic dianhydrides, and the like. As specific examples, there may be cited 3,3′,4,4′-biphenyltetracarboxylic dianhydride, pyromellitic dianhydride, 3,3′,4,4′-oxydiphthalic dianhydride, diphenylsulfone-3,4,3′,4′-tetracarboxylic dianhydride, bis(3,4-dicarboxyphenyl)sulfide dianhydride, 2,2-bis(3,4-dicarboxyphenyl)-1,1,1,3,3,3-hexafluoropropane dianhydride, and the like.

As the aforementioned diamine component, there may be cited aromatic diamines, aliphatic diamines, alicyclic diamines, and the like. As specific examples, there may be cited p-phenylenediamine, 4,4′-diaminodiphenyl ether, 3,4′-diaminodiphenyl ether, m-tolidine, p-tolidine, 5-amino-2-(p-aminophenyl)benzooxazole, 4,4′-diaminobenzanilide, 1,3-bis(4-aminophenoxy)benzene, 1,4-bis(3-aminophenoxy)benzene, 1,4-bis(aminophenoxy)benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane, and the like.

The following (1) to (6) may be cited as example combinations of the tetracarboxylic acid component and the diamine component. These combinations are preferred, from the standpoint of mechanical characteristics and heat resistance.

(1) A combination of 3,3′,4,4′-biphenyltetracarboxylic dianhydride and p-phenylenediamine.

(2) A combination of 3,3′,4,4′-biphenyltetracarboxylic dianhydride, p-phenylenediamine, and 4,4′-diaminodiphenyl ether.

(3) A combination of pyromellitic dianhydride and p-phenylenediamine.

(4) A combination of pyromellitic dianhydride, p-phenylenediamine, and 4,4′-diaminodiphenyl ether.

(5) A combination of 3,3′,4,4′-biphenyltetracarboxylic dianhydride, pyromellitic dianhydride, and p-phenylenediamine.

(6) A combination of 3,3′,4,4′-biphenyltetracarboxylic dianhydride, pyromellitic dianhydride, p-phenylenediamine, and 4,4′-diaminodiphenyl ether.

(Solvent)

The solvent may be any one in which the polyamic acid can be dissolved. For example, organic solvents such as N-methyl-2-pyrrolidone, N,N-dimethylformamide, N,N-dimethylacetamide, N,N-diethylacetamide, and the like may be cited. These solvents may be used individually, or two or more employed concomitantly.

(Organic Material)

The organic material employed in the present invention differs from the polyamic acid and the solvent. In the course of generating the polyamide through heating of the first polyimide precursor solution which has been cast or applied onto the support, the organic material employed in the present invention undergoes phase separation from the polyimide precursor to constitute a given volume, and is eliminated from the polyimide film through thermal decomposition or vaporization through heating. Through elimination of the organic material from the polyimide film, crater-shaped recessed portions are formed in sections in which the organic material is present, whereby recesses and protrusions are formed in the surface layer of the polyimide film. In the present invention, organic material refers to a concept that excludes catalysts and dehydrating agents employed during imidization. During elimination of the organic material from the polyimide film through thermal decomposition or vaporization through heating, there will be cases in which the organic material is not completely eliminated, and a certain quantity remains in the polyimide film; this mode also falls within the scope of the present invention.

The volatilization temperature of the organic material is preferably lower than the volatilization temperature of the polyimide obtained through imidization of the polyamic acid. Herein, “volatilization temperature” refers to a temperature at which the volatilized amount of the organic material or the polyimide is 50 mass % or above. In the present invention, “volatilization” refers to [a process whereby] some of all of the organic material or the polyimide is transformed to a volatile component through thermal decomposition, or is transformed into a gaseous component and dispersed through heat-induced vaporization or the like, reducing the mass.

In preferred practice, the volatilized amount at 450° C. of the polyimide obtained through imidization of the polyamic acid is 5 mass % or less.

In the present invention, organic materials as indicated in (a) and/or (b) below can be employed in preferred fashion as the organic material.

(a) Organic materials capable of dissolving in the solvent in the polyamic acid solution.

(b) Organic materials molded into a particulate, and incompatible with the solvent in the polyamic acid solution.

Especially preferred are organic materials indicated by (a), as these, when added to the polyamic acid solution, form a homogeneous solution, and do not give rise to coagulation, setting, or separation when a non-soluble fraction is added. Hereinafter, an organic material indicated by (a) shall be referred to as an organic material (a), and an organic material indicated by (b) shall be referred to as an organic material (b).

The organic material (a) is “capable of dissolving in the solvent in the polyamic acid solution,” wherein “dissolving” refers to a state in which, when the organic material is added to the polyamic acid solution, the organic material elutes into the solvent, and the solid component substantially disappears.

The organic material (a) is preferably one that dissolves to 5 mass % or greater in the polyamic acid solution. As specific examples of the organic material (a), there may be cited polymethyacrylates, polyacrylates, and cellulose compounds. As more specific examples of the organic material (a), there may be cited polymethyl methacrylate, polyethyl methacrylate, and other polyalkyl methacrylates, poly 2-ethylhexyl acrylate, polybutyl acrylate, and other polyalkyl acrylates, and cellulose acetate. The organic material (a) is preferably at least one selected from polymethyl methacrylate, poly 2-ethylhexyl acrylate, polybutyl acrylate, and cellulose acetate, and more preferably at least one selected from polymethyl methacrylate and cellulose acetate.

The weight-average molecular weight (Mw) of the organic material (a) is preferably 1,000-1,000,000, and more preferably 2,000-500,000. By employing an organic material of high weight-average molecular weight, the depth and diameter of the recessed portions can be made larger. By employing an organic material of low weight-average molecular weight, the depth and diameter of the recessed portions can be made smaller.

The average particle diameter of the organic material (b) is preferably 1-10 μm, and more preferably 2-8 μm. When the average particle diameter is within the aforementioned range, good performance regarding the formation of a variety of thin films is realized, and it is possible to produce polyimide films on the surfaces of which it is possible to form electrode layers having exceptional light reflectivity, or circuit patterns of good cohesion. As specific examples of the organic material (b) there may be cited crosslinked methyl methacrylate particles, polystyrene particles, other polymer material particles of copolymerized double-bond-containing monomers, and the like. The organic material (b) is preferably one or more selected from crosslinked methyl methacrylate particles and polystyrene particles.

In the present invention, the organic material (b) is “incompatible with the solvent in the polyamic acid solution,” meaning that when the organic material is added to the polyamic acid solution, the organic material holds its shape. Even when an organic material partially dissolves, it is nevertheless preferred for use as the organic material (b), as long as a solid component is contained. Even in cases in which the organic material swells, as long as it maintains its shape, it is considered to be included among organic materials that are “incompatible with the solvent in the polyamic acid solution,” and can be used preferentially.

The organic material is preferably one for which the volatilized amount at 400° C. is 95 mass % or greater, and more preferably 99 mass % or greater. Here, the volatilized amount at 400° C. refers to the decrease in weight when the organic material is heated in air at 400° C. for one hour. When the volatilized amount at 400° C. is less than 95 mass %, there will be cases in which the appearance of the polyimide film is adversely affected by organic material residue. In order to prevent the appearance from being adversely affected, it will be necessary for heating to take place at high temperature, with the possibility that the characteristics of the polyimide film will be degraded. Moreover, it is possible that high temperatures will lead to higher production costs.

With the aim of controlling the diameter, depth, shape, and dispersion of the crater-shaped recessed portions formed on the surface of the polyimide film, the organic material (a) and the organic material (b) may be employed subsequently, in a form having been modified by functional groups, such as carboxylic acids, carboxylic anhydrides, epoxy groups, amino groups, alkoxysilanes, or the like. These functional groups may be reacted in advance with polyamic acid to form a copolymer which is then applied, or applied in the unreacted state, and then reacted during drying. Known dispersants and compatibilizing agents may be added as well.

The organic material may be added during the reaction of the aforementioned tetracarboxylic acid component and the diamine component in the solvent, or added to the polyamic acid solution obtained by reacting the tetracarboxylic acid component and the diamine component in the solvent.

The organic material content of the first polyimide precursor solution is preferably 0.2-10 mass %, and more preferably 1-5 mass %. When the organic material content is less than 0.2 mass %, there are cases in which it will be difficult to form crater-shaped recessed portions on the surface of the polyimide film, making it difficult to obtain a polyimide film on the surfaces of which it is possible to form electrode layers having exceptional light reflectivity or the like. When the organic material content exceeds 10 mass %, the strength of the polyimide film tends to be lower. Moreover, in some cases, the solution is highly viscous and difficult to handle.

(Other Components)

In the present invention, a phosphorus based stabilizer can be added to the first polyimide precursor solution during polymerization of the polyamic acid, with the aim of limiting gelation of the polyamic acid solution. As phosphorus based stabilizers there may be cited, for example, triphenyl phosphite, triphenyl phosphate, and the like. The added amount of the phosphorus based stabilizer is preferably 0.01-1% with respect to the solids fraction (polymer) concentration.

A filler can also be added to the first polyimide precursor solution. As fillers, there may be cited silica, alumina, and other such inorganic fillers, or polyimide particles and other organic fillers. In the present invention, the organic material contained in the first polyimide precursor solution undergoes thermal decomposition and vaporization during imidization of the polyamic acid, thereby forming crater-shaped recessed portions on the surface of the polyimide film, and therefore a polyimide film having recesses and protrusions on the surface can be formed without employing fillers. With a polyimide film having recesses and protrusions formed on the surface without employing fillers (an all-polyimide [film]), reduced cost of the polyimide film may be achieved, due to the fact that no fillers are employed, and furthermore the shape and height of the recesses and protrusions can be controlled appropriately, to improve the slip properties of the polyimide film surface. Another effect is that in cases in which the polyimide film will be used in applications involving etching, no filler residue remains.

With the aim of accelerating imidization, a basic organic compound can be added to the first polyimide precursor solution. As basic organic compounds there may be cited, for example, imidazole, 2-imidazole, 1,2-dimethylimidazole, 2-phenylimidazole, benzimidazole, isoquinoline, substituted pyridine, and the like. The added amount of the basic organic compound is preferably 0.05-10 mass %, preferably 0.1-2 mass %, with respect to the polyamic acid.

In cases in which imidization of the first polyimide precursor solution is brought to completion through hot imidization, an imidization catalyst or the like may be added to the first polyimide precursor solution, as needed. In cases in which imidization of the first polyimide precursor solution is brought to completion through chemical imidization, a cyclization catalyst, dehydrating agent, or the like may be added to the first polyimide precursor solution, as needed.

As the aforementioned imidization catalyst, there may be cited substituted or unsubstituted nitrogen-containing heterocyclic compounds, N-oxide compounds of these nitrogen-containing heterocyclic compounds, substituted or unsubstituted amino acid compounds, and aromatic hydrocarbon compounds or aromatic heterocyclic compounds having hydroxyl groups.

As the aforementioned cyclization catalyst, there may be cited aliphatic tertiary amines, aromatic tertiary amines, heterocyclic tertiary amines, and the like. As specific examples of the cyclization catalyst, there may be cited trimethylamine, triethylamine, dimethylaniline, pyridine, β-picoline, isoquinoline, quinoline, and the like.

As the aforementioned dehydrating agent, there may be cited aliphatic carboxylic anhydrides, aromatic carboxylic anhydrides, and the like. As specific examples of the dehydrating agent, there may be cited acetic anhydride, propionic anhydride, butyric anhydride, formic anhydride, succinic anhydride, maleic anhydride, phthalic anhydride, benzoic anhydride, picolinic anhydride, and the like.

(Polyimide Film Production Method)

### First Embodiment

The method for producing a polyimide film of the present invention involves casting or applying the first polyimide precursor solution containing the organic material onto a support.

In this embodiment, it is preferable to employ a smooth base material as the support; for example, a stainless steel substrate, stainless steel belt, glass plate, or the like may be used.

There are no particular limitations as to the method by which first polyimide precursor solution containing the organic material is cast or applied onto the support, and there may be cited, for example, a gravure coating process, a spin coating process, a silkscreen process, a dip coating process, a spray coating process, a bar coating process, a knife coating process, a roll coating process, a blade coating process, a die coating process, and the like.

After the first polyimide precursor solution containing the organic material has been cast or applied onto the support, it may be dried using a dryer. The drying temperature is preferably 100-200° C., and more preferably 120-180° C. The drying time is preferably 2-60 minutes, and more preferably 3-20 minutes.

After obtaining a first self-supporting film having self-supporting properties by casting or applying the first polyimide precursor solution containing the organic material onto the support and then drying the solution, the first self-supporting film may be peeled from the support, and then subjected to heating, discussed below. This method affords exceptional productivity of polyimide films. Herein, self-supporting refers to a state of having strength such that [the film] can be peeled from the support.

The self-supporting film may be a single-layer film of the first self-supporting film containing the organic material, or a multilayer film of multilayer structure composed of two or more layers, i.e., a layer containing the organic material and a layer not containing the organic material.

The single-layer film can be formed by casting or applying the first polyimide precursor solution containing the organic material into a film on the support and then drying the film through introduction into a drying oven or the like.

The multilayer film can be formed by a method involving formation by applying the first polyimide precursor solution containing the organic material onto a self-supporting film not containing the organic material, and drying, as in the second embodiment discussed below; or a method of formation using a multilayer die to co-extrude a polyimide precursor solution not containing the organic material and the first polyimide precursor solution containing the organic material onto the support, and drying these, as in the third embodiment discussed below.

Next, the applied film formed by the first polyimide precursor solution containing the organic material cast or applied onto the support, or the first self-supporting film peeled from the support in the above manner, is heated. In so doing, elimination of the solvent and imidization are brought to completion, to obtain the polyimide film. During this time, the organic material contained in the first polyimide precursor solution undergoes thermal decomposition and vaporizes, thereby forming crater-shaped recessed portions in the surface of the polyimide film, and forming recesses and protrusions on the polyimide film surface layer. Herein, crater-shaped recessed portions refer to recessed portions of circular or elliptical shape, having a shape which curves substantially smoothly at the bottom face, and slightly raised at the peripheral edge of the opening, such as would be formed by bursting of a spherical or granular shaped bubble.

As the heating means, a heating oven (curing oven) of known type may be cited. As one example of a heating method, it would be appropriate to bring about gradual imidization of the polymer and vaporization/elimination of the solvent at a temperature of approximately 100° C.-400° C., preferably for 0.05-5 hours, and especially preferably for 0.1-3 hours. It is especially preferable for the heating method to be conducted in stepwise fashion. For example, it is preferable to conduct a primary heat treatment at a relatively low temperature of approximately 100° C. to approximately 170° C. for approximately 0.5-30 minutes, followed by a secondary heat treatment at a temperature of 170° C.-220° C. for approximately 0.5-30 minutes, followed by a tertiary heat treatment at a temperature of 220° C.-400° C. for approximately 0.5-30 minutes. As needed, a quaternary heat treatment may be conducted at a high temperature of 400° C.-550° C., and preferably 450-520° C.

In the present invention, the maximum temperature during heating is at or above the volatilization temperature of the organic material contained in the first polyimide precursor solution, and at or below the volatilization temperature of the polyimide obtained by imidization of the polyamic acid. Herein, “polyimide obtained by imidization of the polyamic acid” is equivalent to the polyimide obtained by imidization of the polyamic acid of the first polyimide precursor solution. The volatilization temperature of the organic material will depend on the type of organic material, and is 200-400° C., for example. The volatilization temperature of the polyimide obtained by imidization of the polyamic acid will depend on the type of polyamic acid, and is 300-600° C., for example. The type of organic material and polyamic acid are selected within these volatilization temperatures of the organic material and the polyamide. In the present invention, the polyimide volatilization amount at 450° C. is preferably 5 mass % or less.

For example, in a case in which the organic material is polymethyl methacrylate, the volatilization temperature of the organic material is about 300-400° C. In a case in which the polyimide is one obtained by imidization of polyamic acid composed of 3,3′,4,4′-biphenyltetracarboxylic dianhydride and p-phenylenediamine, the volatilization temperature of the polyimide is 550-650° C.

In the present invention, the maximum temperature during heating is preferably 400-600° C., and more preferably 430-550° C.

During heat treatment to bring imidization to completion, [the film] may be secured within the curing oven by a pin tenter, clips, a frame, or the like, in at least a direction at a right angle to the lengthwise direction of the long solidified film, i.e., along both widthwise edges of the film, and heat treatment conducted under expansion or contraction in the width direction or in the lengthwise direction, as needed.

### Second Embodiment

In this embodiment, employing a second self-supporting film as the support, the first polyimide precursor solution containing the organic material is applied onto the second self-supporting film. The second self-supporting film may be obtained by drying a second polyimide precursor solution. A detailed description follows.

As the second polyimide precursor solution, there is employed one containing polyamic acid and a solvent. The polyamic acid and the solvent employed may be the same as those in the first polyimide precursor solution mentioned previously. The type of polyamic acid and solvent employed in the second polyimide precursor solution may the same as, or different from, those of the first polyimide precursor solution mentioned previously. Like the first polyimide precursor solution, the second polyimide precursor solution may contain an imidization catalyst, cyclization catalyst, dehydrating agent, or the like, added to accelerate imidization, as needed.

The second polyimide precursor solution is cast or applied onto a support and dried to obtain the second self-supporting film having self-supporting properties. As the support, it is preferable to employ a smooth base material; for example, a stainless steel substrate, stainless steel belt, glass plate, or the like may be used. Herein, self-supporting refers to a state of having strength such that [the film] can be peeled from the support. As the drying means, a drying oven of known type may be cited.

There are no particular limitations as to the drying conditions (heating conditions) for forming the second self-supporting film, but the drying temperature is preferably 100-200° C., more preferably 120-180° C. The drying time is preferably 2-60 minutes, and more preferably 3-20 minutes.

In this embodiment, the first polyimide precursor solution containing the organic material is cast or applied onto the resulting second self-supporting film. Casting or applying of the first polyimide precursor solution may be conducted over the entirety or a portion of one or both surfaces of the second self-supporting film after being peeled from the support, or conducted over the entirety or a portion of the surface of the second self-supporting film not contacting the support, prior to being peeled.

During heating to bring about drying and curing of the applied film formed by the first polyimide precursor solution cast or applied onto the second self-supporting film, the organic material contained in the first polyimide precursor solution undergoes thermal decomposition and vaporizes, thereby forming crater-shaped recessed portions on the surface of the polyimide film.

There is no particular limitation as to the solids concentration (polymer component) of the first polyimide precursor solution, provided that the concentration affords a viscosity range appropriate for film production by applying, and is preferably 1-20 mass %, more preferably 1.5-15 mass %, and still more preferably 2-10 mass %.

The 30° C. rotational viscosity of the first polyimide precursor solution is preferably 1-30 centipoise, and more preferably 2-10 centipoise. Operational performance in the applying operation is good when the rotational viscosity is within the aforementioned range.

There is no particular limitation as to the method for applying the first polyimide precursor solution onto the second self-supporting film; for example, a bar coating process, a gravure coating process, a die coating process, or the like can be adopted.

The application quantity of the first polyimide precursor solution is preferably 1-30 g/m², more preferably 3-25 g/m², and especially preferably 5-20 g/m². When the application quantity is less than 1 g/m², uniform application is difficult to achieve, and there are cases in which the organic material is too sparse, so that recesses and protrusions cannot be effectively formed on the surface layer of the polyimide film. When the application quantity exceeds 30 g/m², the application process tends to be uneven, with liquid dripping off during the application process.

Next, the applied film of the first polyimide precursor solution cast or applied onto the second self-supporting film is heated and dried. As the heating means, a drying oven of known type may be cited.

There are no particular limitations as to the heating and drying conditions, but heating is preferably conducted for about 0.5-60 minutes at 60-180° C., and more preferably for 1-5 minutes at 80-150° C.

Next, the second self-supporting film is peeled from the support. There are no particular limitations as to the peeling method, and a method in which the self-supporting film is cooled, then peeled through application of tension via rolls, may be cited.

Next, as in the first embodiment, the self-supporting film of multilayer structure including a laminated layer containing the organic material and a layer not containing the organic material, which has been peeled from the support, is heated to bring solvent elimination and imidization to completion, to obtain the polyimide film. During this process, the organic material contained in the first polyimide precursor solution undergoes thermal decomposition and vaporizes, thereby forming crater-shaped recessed portions on the surface of the polyimide film, and forming recesses and protrusions on the surface of the polyimide film. With this method, formation of recessed portions that pass through between the front and back surfaces of the polyimide film can be minimized, and crater-shaped recessed portions can be effectively formed on the surface layer only. Furthermore, the strength of the polyimide film can be enhanced.

### Third Embodiment

In this embodiment, rather than casting or applying the first polyimide precursor solution onto the support, the first polyimide precursor solution and a third polyimide precursor solution are cast or applied in layers onto the support, and dried to obtain a third self-supporting film, followed by peeling of the third self-supporting film from the support, and heating of the peeled third self-supporting film to produce a polyimide film.

As the third polyimide precursor solution, there is employed one containing polyamic acid and a solvent. The polyamic acid and the solvent employed may be the same as those in the first polyimide precursor solution mentioned previously. The type of polyamic acid and solvent employed in the third polyimide precursor solution may the same as, or different from, those of the first polyimide precursor solution mentioned previously.

As the method by which the first polyimide precursor solution and the third polyimide precursor solution are applied in layers onto the support, there may be cited, for example, a method of applying the third polyimide precursor solution onto the support, then applying the first polyimide precursor solution over the applied third polyimide precursor solution, a co-extrusion-casting film formation process (termed simply multilayer extrusion), or the like. As the support, it is preferable to employ a smooth base material; for example, a stainless steel substrate, stainless steel belt, glass plate, or the like may be used.

A mode in which the first polyimide precursor solution and the third polyimide precursor solution are cast in layers onto the support can be conducted by known methods. For example, the method disclosed in Japanese Laid-Open Patent Application 3-180343 (Japanese Patent Publication 7-102661) or the like may be employed. For example, there may be cited a method in which the first polyimide precursor solution and the third polyimide precursor solution are supplied to an extrusion molding die and cast in layers onto a support, and the resulting article is cast onto a support surface such as a stainless steel mirror surface, belt surface, or the like. The polyimide precursor solution that contacts the support may be the first polyimide precursor solution or the third polyimide precursor solution, with no particular limitation. The first polyimide precursor solution and the third polyimide precursor solution are preferably cast in layers onto the support in such a way that the third polyimide precursor solution contacts the support, and the first polyimide precursor solution is layered onto the third polyimide precursor solution.

The thickness of the layer formed from the first polyimide precursor solution is preferably 0.5-5 μm. The thickness of the layer formed from the third polyimide precursor solution is preferably 5-50 μm. In so doing, there can be obtained a third self-supporting film that may be brought to a semi-cured state or dry state at 100-200° C.

The third self-supporting film peeled from the support is heated in the same manner as in the first embodiment, and solvent elimination and imidization are brought to completion, and obtain a polyimide film. During this process, the organic material contained in the first polyimide precursor solution undergoes thermal decomposition and vaporizes, thereby forming crater-shaped recessed portions on the surface of the polyimide film, and forming recesses and protrusions on the surface layer of the polyimide film.

According to this embodiment, as in the second embodiment, formation of recessed portions that pass through between the front and back surfaces of the polyimide film can be minimized, and crater-shaped recessed portions can be effectively formed on the surface layer only. Furthermore, the strength of the polyimide film can be enhanced.

(Polyimide Film)

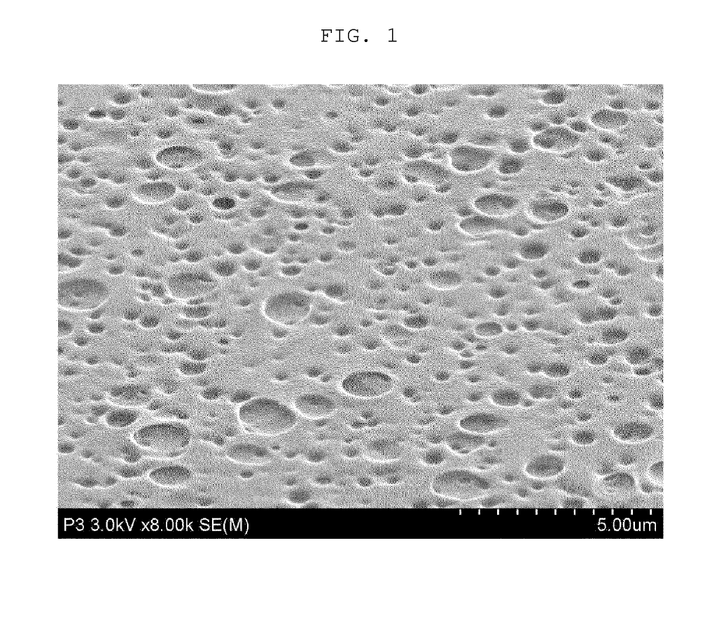

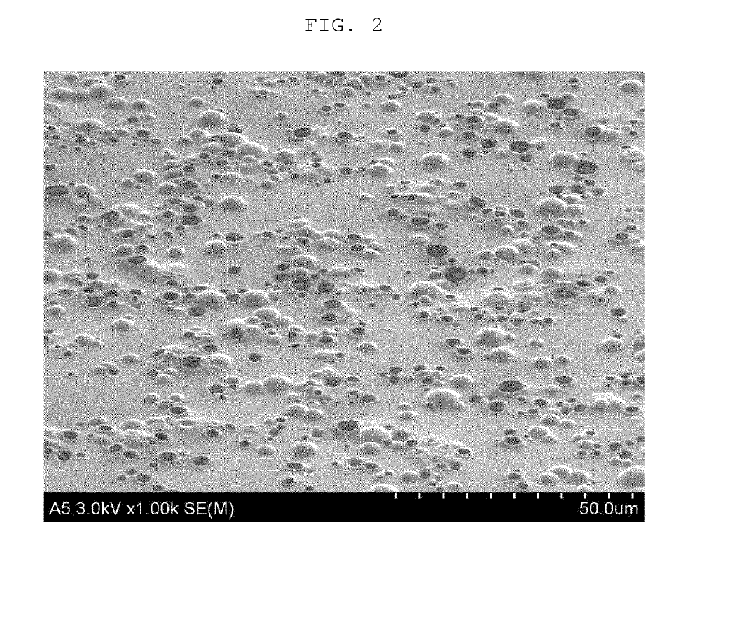

The polyimide film of the present invention is obtained by the aforedescribed production methods, and as shown in FIGS. 1 and 2 has crater-shaped recessed portions formed in the surface layer, forming recesses and protrusions in the surface layer of the polyimide film.

The thickness of the polyimide film is preferably 5-75 μm, for example. The depth of the crater-shaped recessed portions formed in the surface layer of the polyimide film is more than zero but not more than 15 μm, preferably 0.1-5 μm, more preferably 0.1-2 μm, and especially preferably 0.2-1.5 μm. The diameter of the recessed portions is more than zero but not more than 50 μm, preferably 0.1-20 μm, more preferably 0.1-5 μm, still more preferably 0.1-3 μm, and especially preferably 0.1-2 μm.

The average value of the diameter of the recessed portions (average crater diameter) is more than zero but not more than 25 μm, and preferably 0.5-2.5 μm. In the present invention, the diameter of the recessed portions refers to the length of the recessed portions in a horizontal direction.

The value obtained by dividing the average crater diameter of the recessed portions by the depth of the recessed portions (average crater diameter (μm)/recessed portion depth (μm)) is preferably 1.5-3, and more preferably 2-2.5.

The polyimide film of the present invention can be employed as a tape base material for TAB tape, COF tape, or the like, as a cover base material for chip members such as IC chips, as a base substrate or cover base material for liquid crystal displays, organic electroluminescence displays, electronic paper, solar cells, printed circuit boards, and the like, or as other materials for electronic components or electronic devices.

Of these applications, the polyimide film is particularly suitable to be employed as a solar cell substrate, due to its exceptional heat resistance, insulating properties, good deposition properties of thin films of various kinds, and the ability to form electrode layers having exceptional light reflectivity on the surface thereof. Specifically, employing the polyimide film obtained by the production method of the present invention as a substrate for a solar cell, by forming an electrode layer, a photoconversion layer, and a transparent electrode layer in succession on the polyimide film to produce a solar cell, the recesses and protrusions formed on the surface of the polyimide film will efficiently producing scattered reflection of incident light and confining it within the photoconversion layer, so that the efficiency of utilization of light can be enhanced, without adversely affecting the deposition properties of the various thin films or the cohesion, whereby a solar cell having improved generation efficiency can be obtained.

Moreover, as the cohesion of ink or the like printed onto the polyimide film can be enhanced, the film can be suitably employed as a base substrate for a printed circuit board.

(Solar Cell Employing Polyimide Film)

A production method for a solar cell employing a polyimide film obtained according to the present invention as the solar cell substrate will be described below, taking the example of a CIS solar cell.

First, an electrode layer is formed on the polyimide film serving as the substrate. The electrode layer may be a layer of conductive material, typically a metal layer, and preferably an Mo layer. The electrode layer can be formed using a sputtering process or vapor deposition process. In the case of the multilayer polyimide films obtained by the production method of the aforedescribed second embodiment and third embodiment, the electrode layer is formed, for example, on the surface of the surface layer in which recesses and protrusions have been formed.

If needed, a metal base layer can be furnished between the polyimide film substrate and the electrode layer. The metal base layer can be formed, for example, by a sputtering process, or a metallization process such as a vapor deposition process.

Next, a protective layer is formed on the back surface of the substrate (the surface on the opposite side from the side on which the electrode layer was formed). The protective layer preferably has a 25-500° C. linear expansion coefficient of about 1-20 ppm/° C., and especially preferably 1-10 ppm/° C. By furnishing such a protective layer, the occurrence of cracking of the electrode layer or semiconductor layer, and the occurrence of warp of the substrate, can be effectively minimized.

There are no particular limitations as to the protective layer, and a metal layer may be cited, with the same material as the electrode layer being especially preferred, and a Mo layer being more preferred. The protective layer can be formed by a sputtering process or vapor deposition process.

The protective layer may be furnished on an as-needed basis, and in cases in which the polyimide film of the present invention is employed as the substrate, the occurrence of cracking of the electrode layer or semiconductor layer can be minimized to a sufficient extent even when no protective layer is furnished.

There are no particular limitations as to the order of forming the protective layer and the electrode layer. The electrode layer may be formed subsequent to forming the protective layer; in preferred practice, however, the protective layer is formed subsequent to formation of the electrode layer. When the electrode layer and the protective layer are formed in that order, in other words, when the metal layer that was laminated first is used as the electrode, the occurrence of cracking of the electrode layer or semiconductor layer is reduced in some instances.

Next, a thin film layer containing a Group Ib element, a Group IIIb element, and a Group VIb element is formed over the electrode layer. Typically, this thin film layer is a thin film composed only of a Group Ib element, a Group IIIb element, and a Group VIb element, and with subsequent heat treatment forms the light absorbing layer of the solar cell. The Ib element is preferably Cu. The Group IIIb element is preferably at least one element selected from the group consisting of In and Ga. The Group VIb element is preferably at least one element selected from the group consisting of Se and S.

The thin film layer can be formed by a vapor deposition process or sputtering process. The substrate temperature during formation of the thin film layer is, for example, from room temperature (about 20° C.) to about 400° C., and is a lower temperature than the maximum temperature in the subsequent heat treatment. The thin film layer may be a multilayer film composed of a plurality of layers.

A layer containing, for example, a Group Ia element such as Li, Na, or K, or some other layer, may be formed between the electrode layer and the thin film layer. As the layer containing a Group Ia element, there may be cited, for example, a layer composed of Na₂S, NaF, Na₂O₂, Li₂S, or LiF. These layers may be formed by a vapor deposition process or sputtering process.

Next, the thin film layer is heat treated, forming a semiconductor layer (chalcopyrite structure semiconductor layer) containing a Group Ib element, a Group IIIb element, and a Group VIb element. This semiconductor layer functions as the light absorbing layer of the solar cell.

The heat treatment for converting the thin film layer to the semiconductor layer is preferably conducted in an atmosphere of nitrogen gas, oxygen gas, or argon gas. Alternatively, the process may be conducted in a vapor atmosphere containing at least one element selected from the group consisting of Se and S.

The heat treatment is preferably conducted at a temperature elevation rate within a range of 10° C./second to 50° C./second, heating it up to a temperature in the range of 500-550° C., preferably a range of 500° C.-540° C., and more preferably a range of 500° C.-520° C., and thereafter holding the temperature within this range, preferably for 10 seconds to 5 minutes. Thereafter, the thin film layer is allowed to cool naturally, or a heater is employed to cool down the thin film layer at a slower rate than natural cooling.

In this way, a semiconductor layer containing a Group Ib element, a Group IIIb element, and a Group VIb element is formed as a light absorbing layer. The semiconductor layer thusly formed is, for example, a semiconductor layer of CuInSe₂ or Cu (In, Ga) Se₂, or of CuIn (S, Se)₂ or Cu (In, Ga) (S, Se)₂ obtained by substituting S for some of the Se in these compounds.

The semiconductor layer can also be formed in the following manner.

A thin film layer containing a Group Ib element and a Group IIIb element, but not containing a Group VIb element, typically a thin film composed of a Group Ib element and a Group IIIb element only, is formed over the electrode layer. Then, by conducting a heat treatment to convert this thin film layer to a semiconductor layer, doing so in an atmosphere containing a Group VIb element, and preferably a vapor atmosphere containing at least one element selected from the group consisting of Se and S, there can be formed a semiconductor layer containing a Group Ib element, a Group IIIb element, and a Group VIb element. The thin film formation method and conditions of heat treatment are the same as the aforedescribed.

After forming the semiconductor layer, a window layer (or buffer layer) and an upper electrode layer are stacked in order by known methods, and lead electrodes are formed to produce a solar cell. A layer composed, for example, of CdS or of ZnO or Zn (O, S) can be employed as the window layer. The window layer may be two or more layers. A transparent electrode, for example, ITO, ZnO:Al, or the like can be employed as the upper electrode layer. An anti-reflective film of MgF₂ of the like can be furnished on the upper electrode layer.

There are no particular limitations as to the constitution and formation method of each of the layers, and these can be selected as appropriate. In the present invention, a CIS solar cell can be produced by a roll-to-roll system, employing a pliable polyimide film as the substrate.

(Printed Circuit Board Employing Polyimide Film as the Base Substrate)

Next, a production method for a printed circuit board employing a polyimide film obtained according to the present invention as the base substrate will be described.

A conductive pattern is formed on the surface of the polyimide film. As the method for forming the conductive pattern, there may be cited, for example, a method in which a pattern is printed onto polyimide film with an ink or paste incorporating metal particles, and a conductive pattern is formed through a heating process or other subsequent step, as needed. It is a feature of this method that there is no waste associated with eliminating portions of the conducting layer other than the pattern portion, as with the conventional subtractive process, and the impact on the environment is lower as well. The polyimide film obtained according to the present invention has exceptional heat resistance, insulating properties, and good deposition properties of thin films of various kinds, and moreover has greater surface area and an anchoring effect, due to the recesses and protrusions on the surface, thereby affording good cohesion of conductive patterns.

As the ink or paste incorporating metal particles, there can be employed any of a wide range of known or commercially available inks and pastes that contain metal nanoparticles, designed to form conductive patterns. For example, there may be cited “MDot-SLP/H” ™, a silver paste made by Mitsuboshi Belting, “NPS type HP” ™ made by Harima Chemicals, and “CA-2503-4” ™ made by Daiken Chemical. Of these, the “MDot-SLP/H” ™ silver paste made by Mitsuboshi Belting is suitably employed for its good cohesion to condensation product films (sol-gel films). Silver or copper is suitably employed as the metal of the metal nanoparticles.

There are no particular limitations as to the film thickness of the ink or paste incorporating metal particles, subsequent to baking, but the thickness is preferably 0.1-30 μm, more preferably 0.3-20 μm, and especially preferably 0.5-15 μm. In cases in which the film thickness of the ink or paste incorporating metal particles subsequent to baking is thinner than 0.1 μm, there will be cases in which performance as a wiring material is not adequate. In cases of film thickness thicker than 30 μm subsequent to baking, cracks may form.

In the present invention, the ink or paste incorporating metal particles can be printed onto the polyimide film by any of various printing methods or application methods, to form patterns. For example, the desired pattern can be formed by various known printing methods, such as formation of the desired linear pattern by employing a dispenser printing method by which linear applying can be conducted, or formation of the desired linear or planar pattern by employing inkjet printing methods of any of various systems such as thermal, piezo, micropump, or electrostatic systems, relief printing methods, flexographic printing methods, planographic printing methods, intaglio printing methods, gravure printing methods, reverse offset printing methods, sheet screen printing methods, rotary screen printing methods, and the like. Moreover, employing various known coating methods such as gravure roll systems, slot die systems, spin coating systems, or the like, patterns may be formed as a continuous face on all or part of the polyimide film surface. Additionally, by employing an intermittent coating die coater or the like, patterns may be formed as discrete faces on all or part of the polyimide film surface. By employing an immersion coating method (also called a dip system), an ink or paste incorporating metal particles may be deposited over the entire polyimide film, forming a pattern. An ink or paste incorporating metal particles may be deposited directly onto the entirety or a portion of the polyimide film surface. As more preferred printing methods, there can be cited inkjet printing methods, flexographic printing methods, gravure printing methods, reverse offset printing methods, sheet screen printing methods, and rotary screen printing methods.

After pattern formation by these methods, conductive patterns can be formed by baking. While the baking conditions are fairly limited depending on the type of polyimide film being used, higher temperatures are better, due to the excellent conductivity and increased strength of the pattern due to the progress of sintering. For example, baking at 150-550° C. is preferred, and with a view to achieving better conductivity and productivity, baking at 200-300° C. is more preferred.

The conductive pattern formed on the polyimide film may undergo electroless plating to form an electroless metal plating layer. In so doing, the conductivity of the conductive pattern can be improved further. There are no particular limitations as to the metals employed during the process, as long as the metals are capable of being electrolessly plated. For example, in the case of nickel, an electroless nickel plating layer can typically be formed by widely known electroless nickel plating processes. An electroplated layer may be formed over the electroless metal plating layer by conducting electroplating, and the metal employed in electroplating may be the same as, or different from, the metal of the electroless nickel plating layer.

With the printed circuit board according to the present invention, high cohesion of conductive patterns to the base substrate, as well as exceptional conductivity, can be achieved. This printed circuit board is employed as a transparent electromagnetic wave shield employed for bonding to flat display panels of various kinds, such as plasma display panels, liquid crystal panels for airplanes, liquid crystal panels for car navigation units, and the like. The board can also be employed in antennas of various kinds employed for RFID or in a wireless LAN, or for power supply through electromagnetic induction, for electromagnetic wave absorption, or the like. Further, the board can be employed in the production of bus electrodes or address electrodes employed in flat display panels of various kinds, of electronic circuits produced by printing of multiple layers of concomitantly employed semiconductor ink and resistor ink or dielectric ink, or the like.

### EXAMPLES

The effects of the present invention will be described below, through examples and comparative examples.

(1) Method for Measuring Volatile Content

Calculated by placing a sample weighing approximately 0.5 g in a 40 mL aluminum foil petri dish, heating for one hour in a hot air oven at 400° C., 450° C., or 480° C., and measuring the decrease in weight.

(2) Volatilization Temperature of Organic Material

Volatile content at 400° C. was measured by the following method, for polymethyl methacrylate contained in the polyimide precursor solutions of the following Preparation Examples 2-1, 2-5 to 2-10, 2-14, and 2-15, the poly 2-ethylhexyl methacrylate contained in the polyimide precursor solutions of the following Preparation Examples 2-11 and 2-12, the polybutyl acrylate contained in the polyimide precursor solutions of the following Preparation Example 2-13, the cellulose acetate contained in the polyimide precursor solutions of the following Preparation Example 2-2, and the crosslinked methacrylic acid spherical particles contained in the polyimide precursor solution of the following Preparation Example 2-3, and was found to be substantially 100 mass %, 99.5 mass %, 98.1 mass %, 99.2 mass %, and 99.8 mass %, respectively, confirming that the volatilization temperature of all of the compounds was 400° C. or below.

(3) Volatilization Temperature of Polyimide Obtained by Imidization of Polyamic Acid

Volatile content at 450° C. was measured for polyimide obtained by imidization of polyamic acid contained in the polyimide precursor solutions of the following Preparation Examples 2-1 to 2-15, and was found to be 5 mass % or less, confirming that the volatilization temperature of the polyimide was 450° C. or above. Volatile content at 480° C. was measured for the polyimide obtained by imidization of polyamic acid contained in the polyimide precursor solutions of the following Preparation Example 2-1 to 2-8, 2-11, 2-12, and 2-13, specifically, polyimide obtained from 3,3′,4,4′-biphenyltetracarboxylic dianhydride and p-phenylenediamine, and was found to be 3.2 mass % or less, confirming that the volatilization temperature of this polyimide was 480° C. or above.

(4) Measurements of Crater-Shaped Recessed Portions of Polyimide Film

Diameter of Crater-Shaped Recessed Portions

A scanning electron microscope (S-3400N made by Hitachi High Technologies Corp.) was used to take photographs of the surface at 5000× magnification, and the range of crater diameter was evaluated visually.

Average Crater Diameter and Average Crater Depth

Using a three-dimensional non-contact surface profiler (Micromap MM23200-M100 made by Ryoka Systems Inc.), the surface profile was measured at 50× magnification. Craters having depth of 0.1 μm or greater were identified and extracted, and the average crater diameter and average crater depth of these was calculated.

(Preparation of Second Polyimide Precursor Solution)

### Preparation Example 1-1

p-Phenylenediamine (hereinafter denoted as “PPD”) was added as the diamine component to N,N-dimethylacetamide (hereinafter denoted as “DMAc” and stirred to dissolve. To the solution obtained thereby was gradually added 3,3′,4,4′-biphenyltetracarboxylic dianhydride (hereinafter denoted as “s-BPDA” as the tetracarboxylic acid component, to obtain a second polyimide precursor solution 1. The solids concentration was 18 mass %.

### Preparation Example 1-2

4,4′-diaminodiphenyl ether (hereinafter denoted as “DADE”) was added as the diamine component to DMac, and stirred to dissolve. To the solution obtained thereby was gradually added pyromellitic dianhydride (hereinafter denoted as “PMDA” as the tetracarboxylic acid component, to obtain a second polyimide precursor solution 2. The solids concentration was 18 mass %.

### Preparation Example 1-3

PPD and DADE in a 20:80 molar ratio were added as the diamine component to DMAc, and stirred to dissolve. To the solution obtained thereby were gradually added s-BPDA and PMDA in a 20:80 molar ratio as the tetracarboxylic acid component, to obtain a second polyimide precursor solution 3. The solids concentration was 18 mass %.

(Preparation of First Polyimide Precursor Solution)

### Preparation Example 2-1

To DMAc as the solvent were added s-BPDA as the tetracarboxylic acid component, PPD as the diamine component, and, as the organic material, polymethyl methacrylate (extra pure reagent made by Wako Pure Chemical Industries, weight-average molecular weight (Mw) approximately 100,000) capable of dissolving in the solvent, in an amount of 2.5 mass parts per 100 total mass parts of the DMAc, s-BPDA and PPD, stirring for one hour to prepare a first polyimide precursor solution 1 containing the organic material. The polyamic acid content of the first polyimide precursor solution 1 containing the organic material was 2.5 mass %, and the polymethyl methacrylate content was 2.5 mass %. The solution was confirmed to be homogeneous, with the polymethyl methacrylate completely dissolved. The volatile content at 400° C. of the polymethyl methacrylate used was substantially 100 mass %. Hereinbelow, polymethyl methacrylate is sometimes denoted as “PMMA.”

### Preparation Example 2-2

A first polyimide precursor solution 2 containing organic material was prepared in the same manner as in Preparation Example 2-1, except that instead of using polymethyl methacrylate as the organic material as in Preparation Example 2-1, cellulose acetate (extra pure reagent made by Wako Pure Chemical Industries, weight-average molecular weight (Mw) approximately 150,000) capable of dissolving in the solvent, was added in an amount of 2.5 mass parts. The polyamic acid content of the first polyimide precursor solution 2 containing the organic material was 2.5 mass %, and the cellulose acetate content was 2.5 mass %. The solution was confirmed to be homogeneous, with the polymethyl methacrylate completely dissolved. The volatile content at 400° C. of the cellulose acetate used was 99.2 mass %.

### Preparation Example 2-3

A first polyimide precursor solution 3 containing organic material was prepared in the same manner as in Preparation Example 2-1, except that instead of using polymethyl methacrylate as the organic material as in Preparation Example 2-1, spherical particles of crosslinked methyl methacrylate (average particle size 5 μm, made by Sekisui Plastics Co., trade name Techpolymer MBX-5) not compatible with the solvent, were added in an amount of 2.5 mass parts. The polyamic acid content of the first polyimide precursor solution 3 containing the organic material was 2.5 mass %, and the crosslinked methyl methacrylate spherical particle content was 2.5 mass %. The solution took the form of a slurry, and it was confirmed that the crosslinked methyl methacrylate spherical particles retained spherical shape. The volatile content at 400° C. of the crosslinked polymethyl methacrylate spherical particles used was 99.8 mass %.

### Preparation Example 2-4

A first polyimide precursor solution 4 not containing organic material was prepared in the same manner as in Preparation Example 2-1, except that the organic material as in Preparation Example 2-1 was not used.

### Preparation Example 2-5

A first polyimide precursor solution 5 was prepared in the same manner as in Preparation Example 2-1, except that the polyamic acid content in Preparation Example 2-1 was changed to 3.5 mass %, and the polymethyl methacrylate content to 1.5 mass %. The solution was confirmed to be homogeneous, with the polymethyl methacrylate completely dissolved.

### Preparation Example 2-6

A first polyimide precursor solution 6 was prepared in the same manner as in Preparation Example 2-5, except for using, in place of the polymethyl methacrylate in Preparation Example 2-5, one having weight-average molecular weight (Mw) controlled to 100,000 (Wako Pure Chemical Industries, reagent grade). The solution was confirmed to be homogeneous, with the polymethyl methacrylate completely dissolved. The volatile content at 400° C. of the polymethyl methacrylate used was substantially 100 mass %.

### Preparation Example 2-7

A first polyimide precursor solution 7 was prepared in the same manner as in Preparation Example 2-5, except for using, in place of the polymethyl methacrylate in Preparation Example 2-5, one having weight-average molecular weight (Mw) controlled to 350,000 (Wako Pure Chemical Industries, reagent grade). The solution was confirmed to be clear, with the polymethyl methacrylate completely dissolved, but was separated into two phases. Stirring produced a fine emulsified state, the emulsified state being stable for some time. The volatile content at 400° C. of the polymethyl methacrylate used was substantially 100 mass %.

### Preparation Example 2-8

A first polyimide precursor solution 8 was prepared in the same manner as in Preparation Example 2-5, except for using, in place of the polymethyl methacrylate in Preparation Example 2-5, one having weight-average molecular weight (Mw) controlled to 75,000 (Wako Pure Chemical Industries, reagent grade). The solution was confirmed to be homogeneous, with the polymethyl methacrylate completely dissolved. The volatile content at 400° C. of the polymethyl methacrylate used was substantially 100 mass %.

### Preparation Example 2-9

To 95 mass parts of DMAc were added 2.1 mass parts of 2,3,3′,4′-biphenyltetracarboxylic dianhydride (hereinafter denoted as “a-BDPA”) as the tetracarboxylic acid component, 1.4 mass part of DADE as the diamine component, and 1.5 mass part of polymethyl methacrylate (extra pure reagent made by Wako Pure Chemical Industries, weight-average molecular weight (Mw) approximately 100,000) as the organic material, stirring for one hour to prepare a first polyimide precursor solution 9. The solution was confirmed to be homogeneous, with the polymethyl methacrylate completely dissolved.

### Preparation Example 2-10

To DMAc were added PPD as the diamine component, and polymethyl methacrylate (made by Wako Pure Chemical Industries, reagent grade, weight-average molecular weight (Mw) approximately 100,000) as the organic component, and stirred to dissolve. s-SPDA was added gradually as the tetracarboxylic acid component to the solution obtained thereby, to obtain a first polyimide precursor solution 10. The polyamic acid concentration was 12.6 mass %, and the polymethyl methacrylate concentration was 5.4 mass %.

### Preparation Example 2-11

A first polyimide precursor solution 11 containing organic material was prepared in the same manner as in Preparation Example 2-1, except that instead of using polymethyl methacrylate as the organic material as in Preparation Example 2-1, carboxyl-group-containing poly 2-ethylhexyl acrylate (Actflow CB3060 made by Soken Chemical & Engineering, weight-average molecular weight (Mw) approximately 3,000, acid value 60 mgKOH/g) capable of dissolving in the solvent was added in an amount of 2.5 mass parts. The polyamic acid content of the first polyimide precursor solution 11 containing the organic material was 2.5 mass %, and the poly 2-ethylhexyl acrylate content was 2.5 mass %. The solution was confirmed to be homogeneous, with the poly 2-ethylhexyl acrylate completely dissolved. The volatile content at 400° C. of the poly 2-ethylhexyl acrylate used was 99.5 mass %.

### Preparation Example 2-12

A first polyimide precursor solution 12 containing organic material was prepared in the same manner as in Preparation Example 2-11, except for using as the carboxyl-group-containing poly 2-ethylhexyl acrylate in Preparation Example 2-11 one having a weight-average molecular weight (Mw) of approximately 3,000 and an acid value of 98 mgOH/g (Actflow CB3098 made by Soken Chemical & Engineering). The polyamic acid content of the first polyimide precursor solution 12 containing the organic material was 2.5 mass %, and the carboxyl group-containing poly 2-ethylhexyl acrylate content was 2.5 mass %. The solution was confirmed to be homogeneous, with the carboxyl group-containing poly 2-ethylhexyl acrylate completely dissolved. The volatile content at 400° C. of the carboxyl group-containing poly 2-ethylhexyl acrylate used was 99.5 mass %.

### Preparation Example 2-13

A first polyimide precursor solution 13 containing organic material was prepared in the same manner as in Preparation Example 2-1, except for adding 2.5 mass parts of a silyl group-containing polybutyl acrylate (Actflow NE1000 made by Soken Chemical & Engineering, weight-average molecular weight (Mw) approximately 3,000, silyl groups 7%) capable of dissolving in the solvent, as the organic material in place of polymethyl methacrylate in Preparation Example 2-1. The polyamic acid content of the first polyimide precursor solution 13 containing the organic material was 2.5 mass %, and the silyl group-containing polybutyl acrylate content was 2.5 mass %. The solution was confirmed to be homogeneous, with the silyl group-containing polybutyl acrylate completely dissolved. The volatile content at 400° C. of the silyl group-containing polybutyl acrylate used was 98.1 mass %.

### Preparation Example 2-14

A first polyimide precursor solution 14 containing an organic material was prepared in the same manner as in Preparation Example 2-1, except for using DADE as a starting material in place of PPD, for the diamine component, and using PMDA in place of s-BPDA as a starting material, for the tetracarboxylic acid component.

### Preparation Example 2-15

A first polyimide precursor solution 15 containing an organic material was prepared in the same manner as in Preparation Example 2-1, except for using PPD and DADE (in a 20:80 molar ratio) as a starting material in place of PPD, for the diamine component, and using BPDA and PMDA (in a 20:80 molar ratio) in place of s-BPDA as a starting material, for the tetracarboxylic acid component.

(Production of Polyimide Film)

### Example 1

The second polyimide precursor solution containing organic material produced in Preparation Example 1-1 was cast onto a glass plate to a final dry thickness of 50 μm, and dried at 120° C. for 20 minutes to give a second self-supporting film. Using a bar coater, this second self-supporting film was applied at a rate of 12 g/m² with the first polyimide precursor solution 1 obtained in Preparation Example 2-1, dried at 120° C. for 2 minutes, and then peeled from the glass plate. The peeled film, while stretched in a square tenter, was heated and dried in succession at 150° C.×2 minutes, 200° C.×2 minutes, 250° C.×2 minutes, and 450° C.×2 minutes, to bring about imidization and produce a polyimide film. The final heating temperature was 450° C. The polyimide film obtained thereby was 30 μm in thickness. Crater-shaped recessed portions about 1-20 μm in diameter had formed on the surface of the polyimide film. An image (8000×) of the polyimide film observed with a scanning electron microscope (SEM) is shown in FIG. 1.

### Example 2

The same procedure as in Example 1 was followed to produce a polyimide film, except for employing the first polyimide precursor solution 2 containing organic material obtained in Preparation Example 2-2, in place of the first polyimide precursor solution 1 containing organic material in Example 1. Crater-shaped recessed portions about 1-20 μm in diameter had formed on the surface of the polyimide film obtained.

### Example 3

The same procedure as in Example 1 was followed to produce a polyimide film, except for employing the first polyimide precursor solution 3 containing organic material obtained in Preparation Example 2-3, in place of the first polyimide precursor solution 1 containing organic material in Example 1. Crater-shaped recessed portions about 10-50 μm in diameter had formed on the surface of the polyimide film obtained. An image (1000×) of the polyimide film observed with a scanning electron microscope (SEM) is shown in FIG. 2.

### Example 4

The same procedure as in Example 1 was followed to produce a polyimide film, except for casting the second polyimide precursor solution onto a glass plate such that the thickness of the polyimide film was 25 μm subsequent to final drying. Microscopic crater-shaped recessed portions about 0.5-2 μm in diameter formed on the surface of the polyimide film obtained thereby.

### Example 5

The same procedure as in Example 4 was followed to produce a polyimide film, except for employing the first polyimide precursor solution 6 obtained in Preparation Example 2-6 in place of the first polyimide precursor solution 1 in Example 4. Microscopic crater-shaped recessed portions about 0.5-2 μm in diameter formed on the surface of the polyimide film obtained thereby.

### Example 6

The same procedure as in Example 4 was followed to produce a polyimide film, except for employing the first polyimide precursor solution 7 obtained in Preparation Example 2-7 in place of the first polyimide precursor solution 1 in Example 4. Crater-shaped recessed portions about 1-20 μm in diameter formed on the surface of the polyimide film obtained thereby.

### Example 7

The same procedure as in Example 4 was followed to produce a polyimide film, except for employing the first polyimide precursor solution 8 obtained in Preparation Example 2-8 in place of the first polyimide precursor solution 1 in Example 4. Microscopic crater-shaped recessed portions about 0.5-2 μm in diameter formed on the surface of the polyimide film obtained thereby.

### Example 8

The same procedure as in Example 4 was followed to produce a polyimide film, except for employing the first polyimide precursor solution 9 obtained in Preparation Example 2-9 in place of the first polyimide precursor solution 1 in Example 4. Microscopic crater-shaped recessed portions about 0.8-5 μm in diameter formed on the surface of the polyimide film obtained thereby.

### Example 9

The second polyimide precursor solution produced in Preparation Example 1-1 was continuously cast from the slit of a T-die mold, such that the thickness of the polyimide film obtained subsequent to final drying was 50 μm, and the material was extruded onto a smooth metal support in a drying oven to form a thin film. After being heated at 130° C. for 10 minutes, the thin film was peeled from the support, yielding a self-supporting film.

The first polyimide precursor solution 1 obtained in Preparation Example 2-1 was continuously applied onto this self-supporting film to a thickness of 14 g/m³, and dried at 80° C. for 2 minutes. The dried film, gripped at both widthwise edges, was introduced into a continuous heating oven, gradually raising the temperature from 200° C., and heating the film under conditions such that a maximum heating temperature of about 500° C. was reached inside the oven during a total residence time of 5 minutes, to bring about imidization and continuously produce an elongated polyimide film.

Microscopic crater-shaped recessed portions about 0.8-2.5 μm in diameter formed on the surface of the polyimide film obtained thereby.

### Example 10

The first polyimide precursor solution produced in Preparation Example 2-10 was cast onto a glass plate such that the thickness subsequent to a final drying would be 50 μm, and dried at 120° C. for 20 minutes to create a self-supporting film. This self-supporting film, while stretched in a square tenter after being peeled from the glass plate, was heated and dried in succession at 150° C.×2 minutes, 200° C.×2 minutes, 250° C.×2 minutes, and 450° C.×2 minutes, to bring about imidization and produce a polyimide film. Crater-shaped recessed portions about 3-20 μm in diameter formed on the surface of the polyimide film obtained thereby.

### Example 11

The same procedure as in Example 4 was followed to produce a polyimide film, except for employing the first polyimide precursor solution 11 obtained in Preparation Example 2-11 in place of the first polyimide precursor solution 1 in Example 4. Microscopic crater-shaped recessed portions about 0.3-2 μm in diameter formed on the surface of the polyimide film obtained thereby.

### Example 12

The same procedure as in Example 4 was followed to produce a polyimide film, except for employing the first polyimide precursor solution 12 obtained in Preparation Example 2-12 in place of the first polyimide precursor solution 1 in Example 4. Microscopic crater-shaped recessed portions about 0.3-3 μm in diameter formed on the surface of the polyimide film obtained thereby.

### Example 13

The same procedure as in Example 4 was followed to produce a polyimide film, except for employing the first polyimide precursor solution 13 obtained in Preparation Example 2-13 in place of the first polyimide precursor solution 1 in Example 4. Microscopic crater-shaped recessed portions about 0.3-2 μm in diameter formed on the surface of the polyimide film obtained thereby.

### Example 14

The same procedure as in Example 4 was followed to produce a polyimide film, except for employing the second polyimide precursor solution 14 obtained in Preparation Example 2-14 in place of the first polyimide precursor solution 1 in Example 4. Microscopic crater-shaped recessed portions about 0.3-2 μm in diameter formed on the surface of the polyimide film obtained thereby.

### Example 15

The same procedure as in Example 4 was followed to produce a polyimide film, except for employing the second polyimide precursor solution 15 obtained in Preparation Example 2-15 in place of the first polyimide precursor solution 1 in Example 4. Microscopic crater-shaped recessed portions about 0.3-2 μm in diameter formed on the surface of the polyimide film obtained thereby.

### Example 16

The same procedure as in Example 4 was followed to produce a polyimide film, except for employing the second polyimide precursor solution 2 (PMDA-DADE) obtained in Preparation Example 1-2 in place of the second polyimide precursor solution 1 in Example 4. Microscopic crater-shaped recessed portions about 0.1-2 μm in diameter formed on the surface of the polyimide film obtained thereby.

### Example 17

The same procedure as in Example 4 was followed to produce a polyimide film, except for employing the second polyimide precursor solution 2 (PMDA-DADE) obtained in Preparation Example 1-2 in place of the second polyimide precursor solution 1, and employing the first polyimide precursor solution 14 (PMDA-DADE) obtained in Preparation Example 2-14 in place of the first polyimide precursor solution 1, in Example 4. Microscopic crater-shaped recessed portions about 0.1-2 μm in diameter formed on the surface of the polyimide film obtained thereby.

### Example 18

The same procedure as in Example 4 was followed to produce a polyimide film, except for employing the second polyimide precursor solution 3 (PMDA-s-BPDA-DADE-PPD) obtained in Preparation Example 1-3 in place of the second polyimide precursor solution 1 in Example 4. Microscopic crater-shaped recessed portions about 0.1-2 μm in diameter formed on the surface of the polyimide film obtained thereby.

### Example 19

The same procedure as in Example 4 was followed to produce a polyimide film, except for employing the second polyimide precursor solution 3 (PMDA-s-BPDA-DADE-PPD) obtained in Preparation Example 1-3 in place of the second polyimide precursor solution 1, and employing the first polyimide precursor solution 15 (PMDA-s-BPDA-DADE-PPD) obtained in Preparation Example 2-15 in place of the first polyimide precursor solution 1, in Example 4. Microscopic crater-shaped recessed portions about 0.1-2 μm in diameter formed on the surface of the polyimide film obtained thereby.

### Comparative Example 1

The same procedure as in Example 1 was followed to produce a polyimide film, except for employing the first polyimide precursor solution 4 not containing organic material, in place of the first polyimide precursor solution 1 containing the organic material in Example 1. The surface of the polyimide film obtained thereby maintained planarity, and microscopic crater-shaped recessed portions did not form.

The shapes of the crater portions of the polyimide films of Examples 1-19 are compiled in Table 1.

TABLE 1

| | | | | | | Second |
|---|---|---|---|---|---|---|
| | First polyamic acid precursor solution | | | | | polyamic |
| | | | | | Polyamic | acid precursor |
| | | | | | acid:organic | solution |
| | Polyamic acid | | | | material | Polyamic acid |
| | Tetracarboxylic | Diamine | | | (mass | Tetracarboxylic |
| | acid component | component | Solvent | Organic material | ratio) | acid component |
| Example 1 | sBPDA | PPD | DMAc | PMMA | 50:50 | sBPDA |
| Example 2 | sBPDA | PPD | DMAc | Cellulose acetate | 50:50 | sBPDA |
| Example 3 | sBPDA | PPD | DMAc | Crosslinked PMMA | 50:50 | sBPDA |
| | | | | spherical particles | | |
| Example 4 | sBPDA | PPD | DMAc | PMMA | 50:50 | sBPDA |
| Example 5 | sBPDA | PPD | DMAc | PMMA(Mw 100,000) | 70:30 | sBPDA |
| Example 6 | sBPDA | PPD | DMAc | PMMA(Mw 350,000) | 70:30 | sBPDA |
| Example 7 | sBPDA | PPD | DMAc | PMMA(Mw 75,000) | 70:30 | sBPDA |
| Example 8 | aBPDA | DADE | DMAc | PMMA | 70:30 | sBPDA |
| Example 9 | sBPDA | PPD | DMAc | PMMA | 50:50 | sBPDA |
| Example 10 | sBPDA | PPD | DMAc | PMMA | 70:30 | — |
| Example 11 | sBPDA | PPD | DMAc | Actflow CB3060 | 50:50 | sBPDA |
| Example 12 | sBPDA | PPD | DMAc | Actflow CB3098 | 50:50 | sBPDA |
| Example 13 | sBPDA | PPD | DMAc | Actflow NE1000 | 50:50 | sBPDA |
| Example 14 | PMDA | DADE | DMAc | PMMA | 50:50 | sBPDA |
| Example 15 | sBPDA/PMDA | PPD/DADE | DMAc | PMMA | 50:50 | sBPDA |
| Example 16 | sBPDA | PPD | DMAc | PMMA | 50:50 | PMDA |
| Example 17 | PMDA | DADE | DMAc | PMMA | 50:50 | PMDA |
| Example 18 | sBPDA | PPD | DMAc | PMMA | 50:50 | sBPDA/PMDA |
| Example 19 | sBPDA/PMDA | PPD/DADE | DMAc | PMMA | 50:50 | sBPDA/PMDA |
| Comparative | sBPDA | PPD | DMAc | None | 100:0 | sBPDA |
| Example 1 | | | | | | |

| | Second | | | | | |
|---|---|---|---|---|---|---|
| | polyamic | | | | | |
| | acid precursor | | | | | |
| | solution | | | | | |
| | Polyamic | | Crater portions | | | |
| | acid | | Diameter | Average | | Average |
| | Diamine | | range | diameter | Depth | diameter/ |
| | component | Solvent | μm | μm | μm | depth |
| Example 1 | PPD | DMAc | 1~20 | 2.15 | 1.22 | 1.76 |
| Example 2 | PPD | DMAc | 1~20 | 2.33 | 1.12 | 2.08 |
| Example 3 | PPD | DMAc | 10~50 | 21.52 | 12.84 | 1.68 |
| Example 4 | PPD | DMAc | 0.5~2 | 1.33 | 0.51 | 2.61 |
| Example 5 | PPD | DMAc | 0.5~2 | 1.28 | 0.50 | 2.56 |
| Example 6 | PPD | DMAc | 1~20 | 3.11 | 1.46 | 2.13 |
| Example 7 | PPD | DMAc | 0.5~2 | 1.19 | 0.43 | 2.77 |
| Example 8 | PPD | DMAc | 0.8~5 | 2.26 | 1.03 | 2.19 |
| Example 9 | PPD | DMAc | 0.8~2.5 | 1.88 | 0.91 | 2.07 |
| Example 10 | — | — | 3~20 | 2.89 | 1.35 | 2.14 |
| Example 11 | PPD | DMAc | 0.3~2 | 0.93 | 0.41 | 2.27 |
| Example 12 | PPD | DMAc | 0.3~3 | 1.05 | 0.48 | 2.19 |
| Example 13 | PPD | DMAc | 0.3~2 | 0.89 | 0.35 | 2.54 |
| Example 14 | PPD | DMAc | 0.3~2 | 0.95 | 0.47 | 2.02 |
| Example 15 | PPD | DMAc | 0.3~2 | 0.92 | 0.44 | 2.09 |
| Example 16 | DADE | DMAc | 0.1~2 | 0.87 | 0.39 | 2.23 |
| Example 17 | DADE | DMAc | 0.1~2 | 0.71 | 0.32 | 2.22 |
| Example 18 | PPD/DADE | DMAc | 0.1~2 | 0.68 | 0.29 | 2.34 |
| Example 19 | PPD/DADE | DMAc | 0.1~2 | 0.72 | 0.34 | 2.12 |
| Comparative | PPD | DMAc | None | — | — | — |
| Example 1 | | | | | | |

### Example 20

The polyimide film obtained in Example 12, in which microscopic crater-shaped recessed portions were formed, was printed with ink containing silver nanoparticles (Mdot made by Mitsuboshi Belting), and baked at 250° C. for 30 minutes. The polyimide-silver complex obtained thereby was evaluated for cohesion in a checkerboard peel test in accordance with JIS K5400. As a result, there were 0/100 peeled portions, and complete cohesion was demonstrated.

### Comparative Example 2

The polyimide film obtained in Comparative Example 1, in which no craters were formed, was employed to prepare a polyimide-silver complex by the same procedure as Example 23, and a checkerboard peel test was conducted. As a result, there were 100/100 peeled portions, and the whole surface peeled.

1. A method for producing a polyimide film in which a first polyimide precursor solution containing a polyamic acid and a solvent is cast or applied onto a support and heated, wherein the method for producing a polyimide having recessed and projected portions formed on a surface layer is characterized in that
the first polyimide precursor solution contains an organic material different from the polyamic acid and the solvent;
the volatilization temperature of the organic material is lower than the volatilization temperature of the polyimide obtained by imidization of the polyamic acid;
the maximum temperature during the heating is at or above the volatilization temperature of the organic material, and at or below the volatilization temperature of the polyimide; and
in the process of heating the first polyimide precursor solution cast or applied onto the support and forming a polyimide, the organic material experiences phase separation from the phase of the polyimide precursor, and is eliminated from the polyimide film through thermal decomposition or vaporization due to the heating.

2. The method for producing a polyimide film according to claim 1, wherein the organic material is subjected to thermal decomposition or vaporization to form crater-shaped recessed portions in a surface layer of the polyimide film.

3. The method for producing a polyimide film according to claim 1, wherein the first polyimide precursor solution is cast or applied onto a support, followed by drying to obtain a first self-supporting film, followed by peeling the first self-supporting film from the support, and heating the peeled first self-supporting film.

4. The method for producing a polyimide film according to claim 1, wherein the support is a second self-supporting film obtained by drying of a second polyimide precursor solution.

5. The method for producing a polyimide film according to claim 1, wherein, rather than casting or applying a first polyimide precursor solution onto a support, a first polyimide precursor solution and a third polyimide precursor solution are cast or applied in layers onto a support and dried to obtain a third self-supporting film, followed by peeling the third self-supporting film from the support, and heating the peeled third self-supporting film.

6. The method for producing a polyimide film according to claim 1, wherein the organic material is an organic material that dissolves in the solvent.

7. The method for producing a polyimide film according to claim 6, wherein the organic material is at least one selected from polymethyl methacrylate, poly 2-ethylhexyl acrylate, polybutyl acrylate, and cellulose acetate.

8. The method for producing a polyimide film according to claim 1, wherein the organic material is an organic material formed into a particulate, and is incompatible with the solvent.

9. The method for producing a polyimide film according to claim 8, wherein the mean particle diameter of the organic material is 1-10 μm.

10. The method for producing a polyimide film according to claim 8, wherein the organic material is at least one organic material selected from crosslinked methyl methacrylate particles and polystyrene particles.

11. The method for producing a polyimide film according to claim 1, wherein the maximum temperature during the heating is 400-600° C.

12. The method for producing a polyimide film according to claim 1, wherein the volatile content of the organic material at 400° C. is 95 mass % or greater.

13. The method for producing a polyimide film according to claim 1, wherein the volatile content of the polyimide at 450° C. is 5 mass % or less.

14-20. (canceled)
